(19) United States
(12) Patent Application Publication
(10) Pub. No.: US 2003/0137836 A1
(43) Pub. Date: Jul. 24, 2003

(54) Christmas bulb set

(76) Inventor: Mei Lan Hsu, Taipei (TW)

Correspondence Address: HSU Mei Lan, PO Box 82-144, TAIPEI, TW

(21) Appl. No.: 10/052,752

(22) Filed: Jan. 23, 2002

(51) Int. Cl. H01R 33/00

(52) U.S. Cl. 362/226; 313/318.05

(57) ABSTRACT

An improved structure of a Christmas bulb set having one bulb and one bulb holder as a unit, within, each output end of a pair of conductor filaments of the bulb being compressed into a square pillar shape; a hole penetrating through the center of the bulb holder allowing both ends of the square pillars to complementary attached to each other; and both positive and negative terminals connected with a wire at their lower ends being inserted into opposite side walls next to the hole characterized by that a circumferential groove being provided to the upper part of the square pillar of the bulb, the filaments being curved by compromising the opposite walls of the square pillar; a flange merely to receive insertion by the bulb groove being extended inwardly from the upper circumference of the hole on the bulb holder with the inner diameter of said flange not greater than the outer diameter of the circumference of the bulb groove to allows direct conduction of the electric circuit with the bulb well secured and prevented from water permeation into the connection end.

### BACKGROUND OF THE INVENTION

(a) Field of the Invention

The present invention is related to an improved structure of Christmas bulb set, and more particularly, to one that allows direct conduction of the electric circuit with the bulb well secured and prevented from water permeation into the connection end.

(b) Description of the Prior Art

Whereas, a conventional bulb set used to decorate a Christmas tree is essentially comprised of a bulb (1), a plastic holder (2) to receive insertion of the base of the bulb and a bulb holder (3) containing both of a positive and a negative terminals as illustrated in FIG. 1 of the accompanying drawings. Though said bulb set has been used for years by the manufacturing trade concerned, there are several areas pending improvement. Firstly, the bulb set relates to an occasional consumption item by year. Therefore, how to effectively lower production cost, thus the selling price is directly related to the market competition strength. However, either in labor costs, work hours and materials, an effective reduction is prevented due to complicate components required. Secondly, storm water can easily permeate through where the bulb (1) is connected to the plastic holder (2) to cause failure to the serial passage. So far, there is no effective solution to the permeation problem, thus an improvement is required. Accordingly, how to provide a Christmas bulb set that can effectively and significantly reduce process costs and prevent from water seepage constitutes the motivation and key issue of design for the present invention.

### SUMMARY OF THE INVENTION

The primary purpose of the present invention is to provide an improved structure for a Christmas bulb set that allows direct conduction of the electric circuit with the bulb well secured and prevented from water permeation into the connection end. To achieve the purpose, a bulb and a bulb holder constitutes a unit of the present invention. Wherein, each output end of a pair of conductor filaments of the bulb being compressed into a square pillar shape; a hole penetrating through the center of the bulb holder allowing both ends of the square pillars to complementary attached to each other; and both positive and negative terminals connected with a wire at their lower ends being inserted into opposite side walls next to the hole characterized by that a circumferential groove being provided to the upper part of the square pillar of the bulb, the filaments being curved by compromising the opposite walls of the square pillar; a flange merely to receive insertion by the bulb groove being extended inwardly from the upper circumference of the hole on the bulb holder with the inner diameter of said flange not greater than the outer diameter of the circumference of the bulb groove.

Another purpose of the present invention is to provide an improved structure for a Christmas bulb set, wherein, the height of each of two conductor filaments after having been curved is limited to where below the circumferential groove of the bulb to offer the following advantages:

(1) The present invention features compact structure and easy assembly by eliminating the structure of plastic holder as seen in the prior art, thus to significantly the process costs in labor, work hours and materials; and

(2) The bulb is well secured in all orientations with its connection end to effectively prevent water seepage.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF TIE DRAWINGS

FIG. 1 is a schematic view showing a structure of the prior art of a Christmas bulb set;

FIG. 2 is a perspective view of a preferred embodiment of the present invention;

FIG. 3 is an exploded view of the preferred embodiment of the present invention;

FIG. 4 is a front view showing the structural relationship among components of the preferred embodiment of the present invention;

FIG. 5 is a front view showing an assembly of the preferred embodiment of the present invention;

FIG. 6 is a side view showing the structural relationship among components of the preferred embodiment of the present invention; and

FIG. 7 is a side view showing the assembly of the preferred embodiment of the present invention.

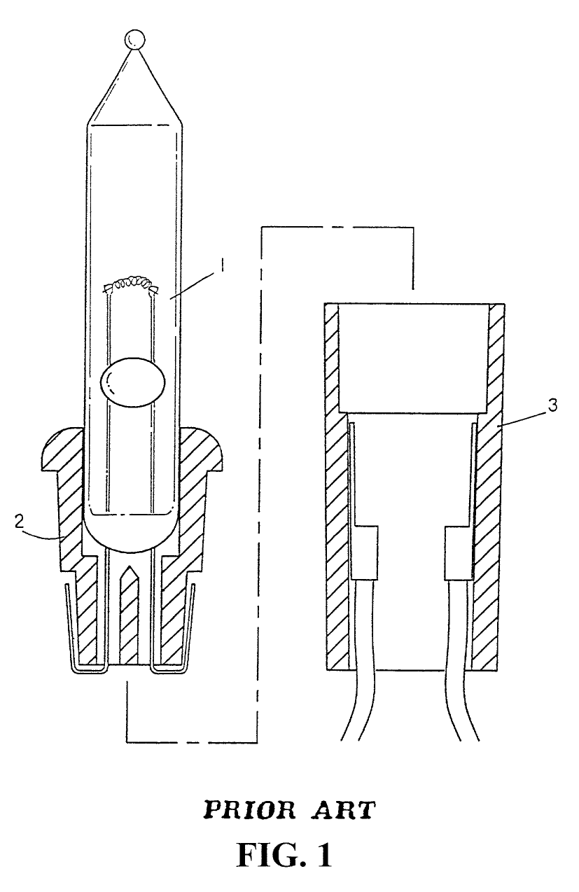

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

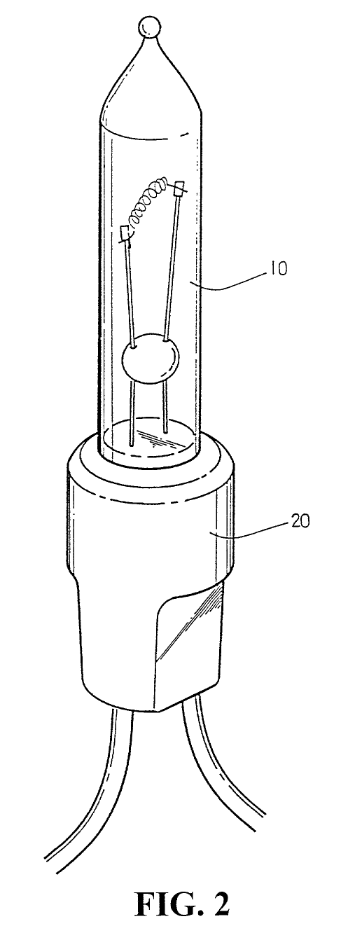

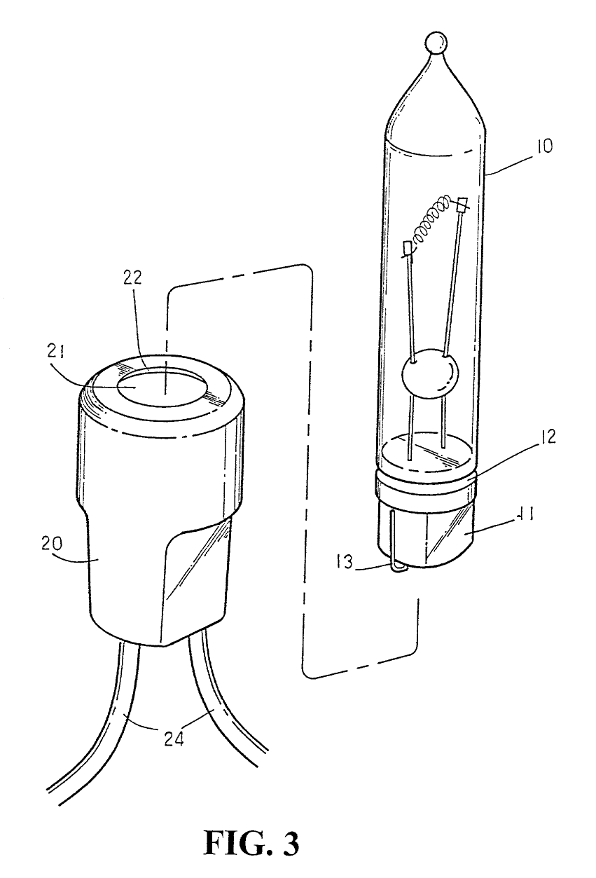

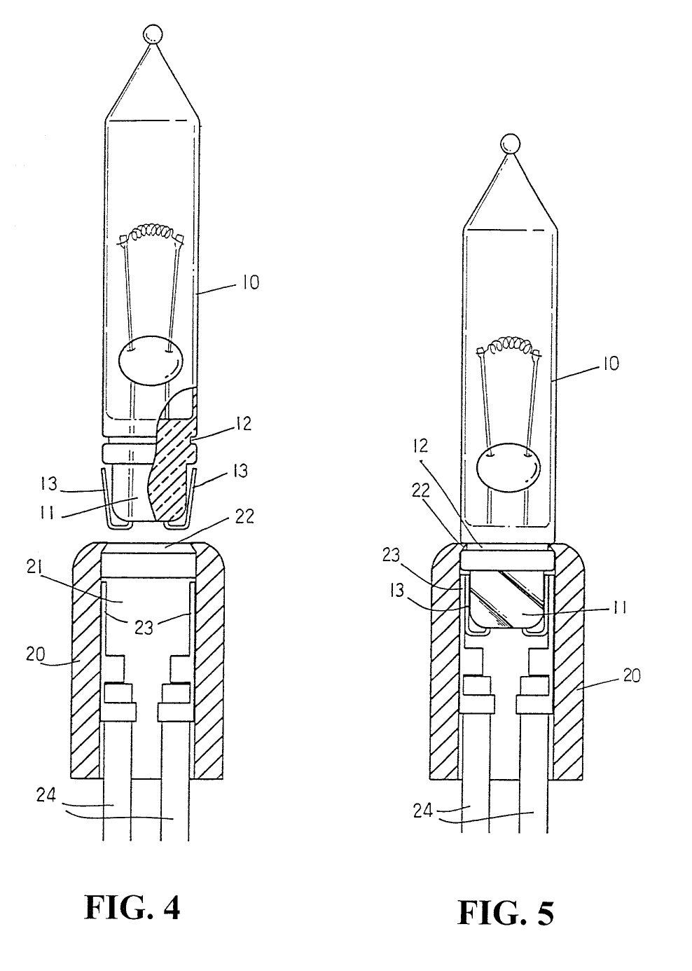

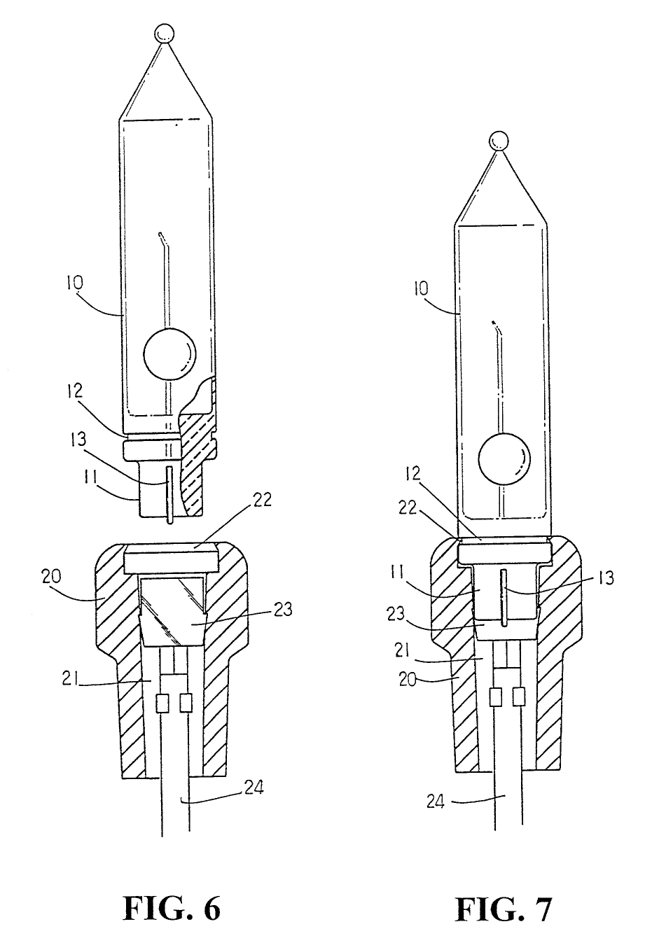

Referring to FIGS. 2 through 7, a Christmas bulb set of a preferred embodiment of the present invention is comprised of a bulb (10) and a bulb holder (20) as a unit. Within, a square pillar (11) with its peripheral slightly smaller than the outer diameter of the bulb case is formed by compression to the closed end at the bottom of said bulb (10). A circumferential groove (12) is provided at a proper height on the upper end of the square pillar (11). Two conductor filaments (13) leading out of the bottom of the bulb are forthwith curved by compromising the opposite sides of the square pillar (11) with the curved portion of each filament (13) at a height below the circumferential groove (12). A hole (20) through the center of the bulb holder (20) is provided to merely allow the insertion of the square pillar (11) of the bulb (10). A flange (22) is formed by extending inwardly on the circumference of the hole (21) with its inner diameter slightly less than the outer diameter of the circumferential groove (12). Both positive and negative terminals (23) having their lower ends connected to a pair of conductors (24) are inserted and secured on the opposite sides in the hole (21). Once assembled, the bulb (10), the curved portions of both conductor filaments (13) hold tightly to both positive and negative terminals (23) that cannot be rotated nor displaced. The flange (22) on the top surface of the bulb holder (20) is merely inserted into the circumferential groove (12) of the bulb (10) to further fasten and secure the bulb (10) to its bulb holder (20). The bulb (10), therefore is prevented from falling off due to external force normally applied to the bulb (10), and from permeation of storm water along the surface of the bulb (10) into the bulb holder (20).

As disclosed, the present invention is compact in structure and easy for assembly. Furthermore, when compared to the structure of the prior art, the present invention eliminates the component of a plastic holder to significantly reduce the process cost and more efficient to prevent permeation of storm water along the surface of the bulb into the bulb holder. Therefore, this application for a utility patent is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a Christmas bulb set, comprised of one bulb and one bulb holder as a unit, within, each output end of a pair of conductor filaments of the bulb being compressed into a square pillar shape; a hole penetrating through the center of the bulb holder allowing both ends of the square pillars to complementary attached to each other; and both positive and negative terminals connected with a wire at their lower ends being inserted into opposite side walls in the hole characterized by that a circumferential groove being provided to the upper part of the square pillar of the bulb, the filaments being curved by compromising the opposite walls of the square pillar; a flange merely to receive insertion by the bulb groove being extended inwardly from the upper circumference of the hole on the bulb holder with the inner diameter of said flange not greater than the outer diameter of the circumference of the bulb groove to allows direct conduction of the electric circuit with the bulb securely retained by the flange of the hole in the bulb holder.

2. An improved structure of a Christmas bulb set as claimed in claim 1, wherein, the curved portion of each filament is at a height below the circumferential groove of the bulb.
